(19) United States
(12) Patent Application Publication
(10) Pub. No.: US 2022/0363175 A1
(43) Pub. Date: Nov. 17, 2022

(54) SELF-RESET AND ANTI-REBOUND ARMREST

(71) Applicant: WINDSOR MACHINE AND STAMPING (2009) LTD., Windsor (CA)

(72) Inventor: William Switalski, Windsor (CA)

(21) Appl. No.: 17/741,624

(22) Filed: May 11, 2022

Related U.S. Application Data
(60) Provisional application No. 63/187,168, filed on May 11, 2021.

(51) Int. Cl. B60N 2/75; B60N 2/90

(52) U.S. Cl. CPC B60N 2/767; B60N 2/938

(57) ABSTRACT

A lockable armrest assembly includes an armrest having a locking member protruding through an arc-shaped opening defined by a latch main body and moveable therein during rotation of the armrest. The lockable armrest assembly further includes a latch assembly operatively coupled to the latch main body, the latch assembly comprising a latch and a spring, the latch pivotably coupled to the latch main body, the spring resisting movement of the latch during acceleration events below a predetermined acceleration threshold to maintain the latch in a non-blocking position, the latch moveable to a blocking position relative to the arc-shaped opening of the latch main body to block movement of the locking member of the armrest in response to an acceleration event greater than the predetermined acceleration threshold to lock the lockable armrest in a stowed condition.

### CROSS-REFERENCED TO RELATED APPLICATION

This application claims the benefits of priority to U.S. Provisional Patent Application Ser. No. 63/187,168, filed May 11, 2021, the disclosure of which is incorporated by reference herein in its entirety.

### FIELD OF THE INVENTION

The invention relates to armrest assemblies and, more particularly, to an armrest capable of locking and resisting deployment during an acceleration event with self-resetting capabilities.

### BACKGROUND OF THE DISCLOSURE

Inertia latches for armrests are designed to prevent deployment of the armrest during forces greater than a predetermined threshold, typically those associated with a vehicle impact event. The latches are intended to move prior to deployment of the armrest to block the armrest. This requires the timing of the latch movement to be critical, but the latch may bounce back to a non-blocking position at a time that causes the armrest to miss the latch. To avoid this issue, some armrest assemblies undesirably require multiple latches with offset timing to provide redundancy. In an effort to avoid the above-described challenges associated with timing, some assemblies lock the latch in a blocking position during an impact event, but this requires a complex resetting procedure.

### SUMMARY OF THE DISCLOSURE

According to one aspect of the disclosure, a lockable armrest assembly includes a latch main body. The lockable armrest assembly also includes an armrest having a locking member extending along a locking member axis and protruding through an arc-shaped opening defined by the latch main body and moveable therein during rotation of the armrest, wherein the armrest is pivotably coupled to the latch main body about a main pivot axis with a pivot pin, wherein the main pivot axis and the locking member axis are parallel. The lockable armrest assembly further includes a latch assembly operatively coupled to the latch main body, the latch assembly comprising a latch and a spring, the latch pivotably coupled to the latch main body, the spring resisting movement of the latch during acceleration events below a predetermined acceleration threshold to maintain the latch in a non-blocking position, the latch moveable to a blocking position relative to the arc-shaped opening of the latch main body to block movement of the locking member of the armrest in response to an acceleration event greater than the predetermined acceleration threshold to lock the lockable armrest in a stowed condition.

According to another aspect of the disclosure, a lockable armrest assembly includes a latch main body. The lockable armrest assembly also includes an armrest having a locking member protruding through an arc-shaped opening defined by the latch main body and moveable therein during rotation of the armrest. The lockable armrest assembly further includes a latch assembly operatively coupled to the latch main body, the latch assembly comprising a latch and a spring, the latch pivotably coupled to the latch main body, the spring resisting movement of the latch during acceleration events below a predetermined acceleration threshold to maintain the latch in a non-blocking position, the latch moveable to a blocking position relative to the arc-shaped opening of the latch main body to block movement of the locking member of the armrest in response to an acceleration event greater than the predetermined acceleration threshold to lock the lockable armrest in a stowed condition, wherein the spring is oriented to bias the latch downwardly and away from the arc-shaped opening, wherein the latch is pivotably coupled to the latch main body with a pin extending from the latch main body into an aperture defined by the latch, wherein the aperture defined by the latch is larger than the pin extending from the latch main body in a direction that allows the latch to move upwardly and downwardly relative to the latch main body.

These and other advantages and features will become more apparent from the following description taken in conjunction with the drawings.

### BRIEF DESCRIPTION OF THE DRAWINGS

The subject matter that is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of an armrest with a latch assembly;

FIG. 2 is a perspective view of the latch assembly;

FIG. 3 is a side view of the latch assembly in a series of actuation positions; and

FIG. 4 is a side view of the latch assembly in various resetting positions.

### DETAILED DESCRIPTION

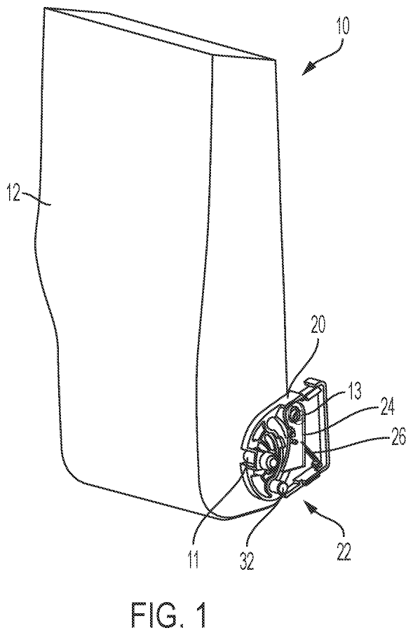

Referring to FIG. 1, an armrest is illustrated and generally referenced with numeral 10. The armrest 10 may be disposed in numerous environments and applications, such as in a vehicle, for example. There are many types of vehicles that the armrest 10 may be disposed in. For example, the vehicle may be a car, truck, sport utility vehicle, crossover, mini-van, marine craft, aircraft, all-terrain vehicle, recreational vehicle, or other another type of vehicle. In some embodiments, the armrest 10 is located proximate a rear seat row or region of an automobile. However, it is to be appreciated that the examples are merely illustrative and are not intended to be limiting. The armrest 10 is shown with a cover 12 that may be any type of suitable material, such as cloth or leather, for example.

The armrest 10 is operatively coupled to a main body 20 of a latch assembly 22. The armrest 10 is pivotably coupled to the relatively stationary main body 20 via a bolt, pin or the like 11. The pivotable connection of the armrest 10 to the main body 20 allows a predetermined angle of rotation for the armrest 10, typically between an upright position and a substantially horizontal position for vehicle occupant comfort. Pivoting of the armrest 10 via the pin or the like 11 (also referred to herein as a “pivot pin”) connection is about a main pivot axis of the armrest 10.

The latch assembly 22 includes an inertia latch 24 (also referred to herein as simply a “latch”) that is coupled to a spring 26. The inertia latch 24 is pivotably coupled to the main body 20 via a bolt, pin or the like 13 extending through an aperture 34 of the inertia latch 24 and into the main body 20. The spring 26 is fixed at a first end of the spring 26 to the main body 20 and at a second end of the spring 26 to the inertia latch 24. The connection of the spring 26 at its second end to the inertia latch 24 may be made in any manner that suitably couples the two components together. For example, the second end of the spring 26 may be formed as a hook or the like that at least partially surrounds a pin or other protrusion of the inertia latch 24. Alternatively, the second end of the spring 26 may include a portion that is retained within a recess, hole or the like that is defined by the inertia latch 24.

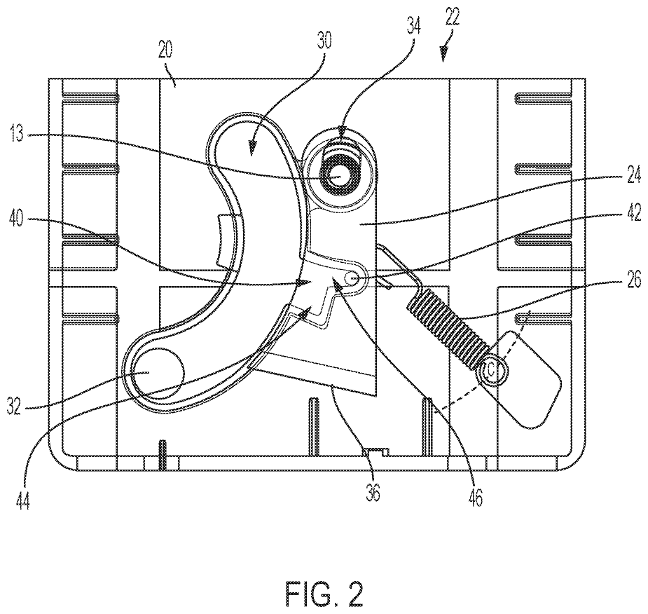

Referring now to FIG. 2, with continued reference to FIG. 1, the main body 20 includes an arc-shaped opening 30 that has a locking member 32 protruding therethrough. The locking member 32 extends along a locking member axis from the armrest 10 in a direction that is substantially parallel to the bolt, pin or the like 11 that facilitates the pivotal connection of the armrest 10 to the main body 20 of the latch assembly 22. The locking member 32 moves within the arc-shaped opening 30 during rotation of the armrest 10, as it is fixed to the armrest 10. The spring 26 biases the inertia latch 24 in a direction that is referred to as rearwardly and downwardly, as viewed in the illustrated orientation. The specific angle of the spring 26 and the spring coefficient are each tunable to provide the particular desired resistance and engagement force characteristics. Biasing due to the spring 26 keeps the inertia latch 24 out of the path of the locking member 32 during rotation of the armrest 10. The inertia latch 24 has a lower edge 36 that is the blocking portion of the inertia latch 24. As disclosed herein, the inertia latch 24 is pivotable between a non-blocking position and a blocking position. The non-blocking position allows the locking member 32 to travel unimpeded through the arc-shaped opening during pivoting of the armrest 10. However, pivoting of the inertia latch 24 away from the non-blocking position to the blocking position results in impact between the locking member 32 and the lower edge 36 of the inertia latch 24. The angle of impact between these structures is tunable.

As discussed above, the inertia latch 24 is pivotably coupled to the main body 20 via the bolt, pin or the like 13 extending through the aperture 34 of the inertia latch 24 and into the main body 20. The aperture 34 of the inertia latch 24 is larger than the bolt, pin or the like 13 in a direction that allows substantially vertical travel of the inertia latch 24. The distance of accommodated vertical travel is tunable based on the design considerations of the particular application of use.

The arc-shaped opening 30 also includes a lateral opening portion generally referenced with numeral 40. A pin 42 extending from the inertia latch 24 is positioned within the lateral opening portion 40. The lateral opening portion 40 also includes a step segment 44 and a slot segment 46. As discussed herein, each segment of the lateral opening portion 40 interacts with the pin 42 at various stages of operation.

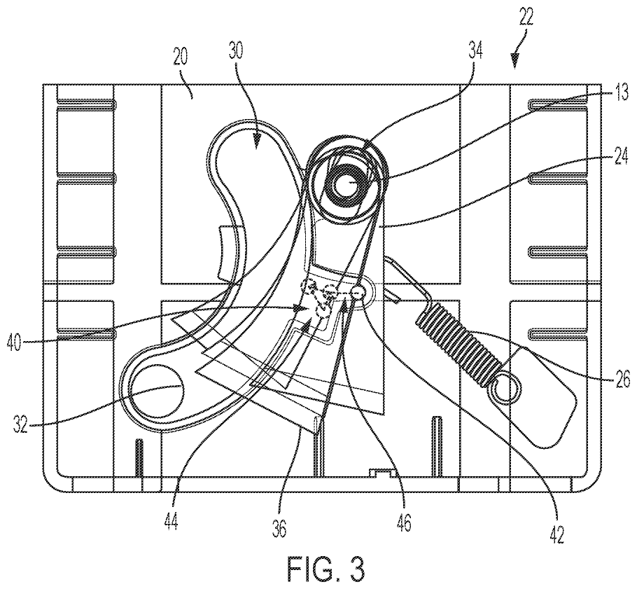

FIG. 3 illustrates a sequence for actuation of the inertia latch 24 during an acceleration event, such as a collision, for example. In the non-blocking position of the inertia latch 24, the latch assembly 22 does not prevent the lockable armrest 10 from deploying, such that manual adjustment by a user is possible since the inertia latch 24 is not positioned to block the locking member 32 as the locking member 32 moves through the arc-shaped opening 32. Deployment of the armrest 10 refers to manipulation, such as via rotation, of the armrest 10 from a substantially upright position to a substantially horizontal position. In the substantially upright position, the armrest 10 is stowed in a manner that does not interfere with seating space of the vehicle, in such applications. Conversely, in the substantially horizontal position, the armrest 10 extends into the seating space to provide one or more benefits, such as a resting surface for an arm.

When in the substantially upright position (e.g., stowed), it is desirable to easily maneuver the armrest 10 from such position to the deployed position, as needed. However, it is also desirable to prevent the armrest 10 from rapidly deploying during an acceleration event, as discussed above. To prevent rapid deployment in such situations, the latch assembly 22 is configured to transition to a locked condition when there is an event where the acceleration (e.g., related to force of impact) is greater than what the inertia spring 26 is designed to resist. In particular, the inertia latch 24 rotates into a position that prevents the locking member 32 from moving completely through the path of defined by the arc-shaped opening 30 when the acceleration exceeds a predetermined acceleration that the inertia spring 26 is designed to resist. In this position, the armrest 10 is unable to deploy due to the locking member 32 being coupled to, or integrally formed with, the armrest 10.

In determining the spring's resistance to movement of the inertia latch 24, the inertia latch's mass and the spring force of the spring 26 are variables. In some embodiments, the acceleration to be resisted is up to 4 g (4.0 times the acceleration of Earth's gravity), however, it is to be understood that the particular acceleration will depend upon the particular application of use.

With continued reference to FIG. 3, the inertial latch 24 is initially positioned such that the pin 42 is located within the slot segment 46. This is referred to as the non-blocking position of the inertia latch 24. In the event of an acceleration event, the inertia latch 24 rotates to move the lower edge 36 of the inertia latch 24 into the arc-shaped opening 30. The movement of the inertia latch 24 during the acceleration event removes the pin 42 from the slot segment 46 and simultaneously results in lowering of the inertia latch 24 due to substantially vertical travel that is provided by the relative dimensioning of the aperture 34 and the bolt, pin or the like 13, as discussed in detail above.

The inertia latch 24 then bounces back toward the step segment 44 due to momentum and the spring force of the spring 26. Due to the lower positioning of the inertia latch 24, which occurs to due to the above-described relationship of the aperture 34 of the inertia latch 24 and the bolt, pin or the like 13, the pin 42 is lower than the slot segment 46, such that it does not bounce back into the slot segment 46. This movement of the inertia latch 24 moves the pin 42 into contact—or in close proximity thereto—with a substantially vertical wall of the step segment 44. The substantially vertical wall of the step segment 44 limits the movement of the inertia latch 24 due to the pin 42 striking the substantially vertical wall. As described above, in this position the pin 42 is below the slot segment 46 so it is not fully recessed therein, thereby causing a portion of the inertia latch 24 to protrude into the arc-shaped opening 30. This blocking of the locking member 32 facilitates easy resetting of the inertia latch 24 simply due to regular rotation of the armrest 10, as described herein.

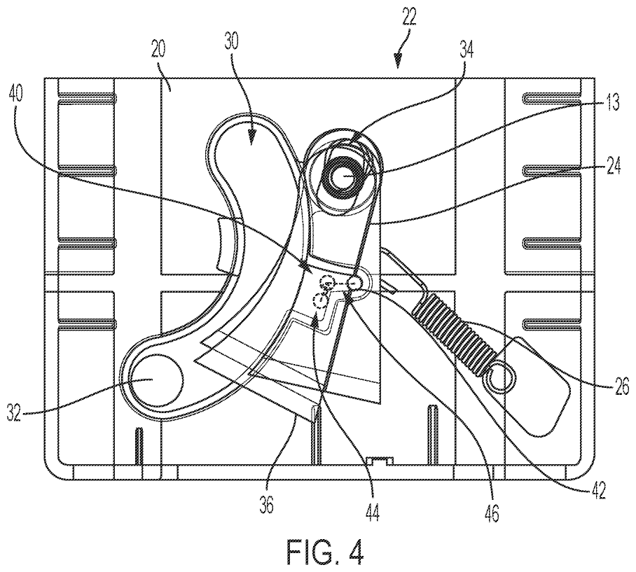

The resetting sequence and associated positions are illustrated in detail in FIG. 4. The above-described manual resetting occurs with typical operation of the armrest 10 and does not require a complicated resetting process after an acceleration event. This is due to the locking member 32 biasing the inertia latch 24 upwardly to allow the pin 42 to reach a position that permits it to enter the slot segment 46 once again. The angle of the spring 26 biases the pin 42 into the slot segment 46 during the manual resetting process. As also shown in FIG. 4, it is possible that the inertia latch 24 is automatically reset during the “bounce back” rotation of the inertia latch 24. Automatic resetting occurs due to the blocking event itself, as the locking member 32 collides with the lower edge 36 of the inertia member 24 in a manner that moves the inertia latch upwardly to a sufficient degree that the pin 42 may enter the slot segment 46. Such a situation comprises the pin 42 entering the slot segment 46 and movement of the armrest 10 is not required. Either situation provides a natural resetting process.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

What is claimed is:

1. A lockable armrest assembly comprising:
a latch main body;
an armrest having a locking member extending along a locking member axis and protruding through an arc-shaped opening defined by the latch main body and moveable therein during rotation of the armrest, wherein the armrest is pivotably coupled to the latch main body about a main pivot axis with a pivot pin, wherein the main pivot axis and the locking member axis are parallel; and
a latch assembly operatively coupled to the latch main body, the latch assembly comprising a latch and a spring, the latch pivotably coupled to the latch main body, the spring resisting movement of the latch during acceleration events below a predetermined acceleration threshold to maintain the latch in a non-blocking position, the latch moveable to a blocking position relative to the arc-shaped opening of the latch main body to block movement of the locking member of the armrest in response to an acceleration event greater than the predetermined acceleration threshold to lock the lockable armrest in a stowed condition.

2. The lockable armrest assembly of claim 1, wherein the latch is pivotably coupled to the latch main body with a pin extending from the latch main body into an aperture defined by the latch.

3. The lockable armrest assembly of claim 2, wherein the aperture defined by the latch is larger than the pin extending from the latch main body in a direction that allows the latch to move upwardly and downwardly relative to the latch main body.

4. The lockable armrest assembly of claim 3, further comprising a lateral opening segment that is part of the overall opening of the arc-shaped opening, wherein the latch includes a pin extending therefrom, the pin disposed within a slot segment of a lateral opening portion in the non-blocking position.

5. The lockable armrest assembly of claim 4, wherein the pin is positioned within a step segment of the lateral opening segment in the blocking position of the latch, the step segment being lower than the slot segment and closer to the arc-shaped opening relative to the distance between the slot segment and the arc-shaped opening.

6. The lockable armrest assembly of claim 1, wherein the spring is oriented to bias the latch downwardly and away from the arc-shaped opening.

7. The lockable armrest assembly of claim 1, wherein the spring resists movement of the latch away from the non-blocking position up to an acceleration that is 4.0 times the acceleration of Earth's gravity.

8. The lockable armrest assembly of claim 1, wherein the latch is manually resettable from the blocking position to the non-blocking position after deployment during manually actuated pivoting of the armrest based on contact between the locking member and the latch to bias the latch upwardly to allow the pin to enter the slot segment.

9. The lockable armrest assembly of claim 1, wherein the latch is automatically resettable from the blocking position to the non-blocking position after deployment based on contact between the locking member and the latch after blocking of the locking member to bias the latch upwardly to allow the pin to enter the slot segment.

10. A lockable armrest assembly comprising:
a latch main body;
an armrest having a locking member protruding through an arc-shaped opening defined by the latch main body and moveable therein during rotation of the armrest; and
a latch assembly operatively coupled to the latch main body, the latch assembly comprising a latch and a spring, the latch pivotably coupled to the latch main body, the spring resisting movement of the latch during acceleration events below a predetermined acceleration threshold to maintain the latch in a non-blocking position, the latch moveable to a blocking position relative to the arc-shaped opening of the latch main body to block movement of the locking member of the armrest in response to an acceleration event greater than the predetermined acceleration threshold to lock the lockable armrest in a stowed condition, wherein the spring is oriented to bias the latch downwardly and away from the arc-shaped opening, wherein the latch is pivotably coupled to the latch main body with a pin extending from the latch main body into an aperture defined by the latch, wherein the aperture defined by the latch is larger than the pin extending from the latch main body in a direction that allows the latch to move upwardly and downwardly relative to the latch main body.

11. The lockable armrest assembly of claim 10, further comprising a lateral opening segment that is part of the overall opening of the arc-shaped opening, wherein the latch includes a pin extending therefrom, the pin disposed within a slot segment of a lateral opening portion in the non-blocking position.

12. The lockable armrest assembly of claim 11, wherein the pin is positioned within a step segment of the lateral opening segment in the blocking position of the latch, the step segment being lower than the slot segment and closer to the arc-shaped opening relative to the distance between the slot segment and the arc-shaped opening.

13. The lockable armrest assembly of claim 10, wherein the spring resists movement of the latch away from the non-blocking position up to an acceleration that is 4.0 times the acceleration of Earth's gravity.

14. The lockable armrest assembly of claim 10, wherein the latch is manually resettable from the blocking position to the non-blocking position after deployment during manually actuated pivoting of the armrest based on contact between the locking member and the latch to bias the latch upwardly to allow the pin to enter the slot segment.

15. The lockable armrest assembly of claim 10, wherein the latch is automatically resettable from the blocking position to the non-blocking position after deployment based on contact between the locking member and the latch after blocking of the locking member to bias the latch upwardly to allow the pin to enter the slot segment.

16. The lockable armrest assembly of claim 10, wherein the locking member extends along a locking member axis, wherein the armrest is pivotably coupled to the latch main body about a main pivot axis with a pivot pin, wherein the main pivot axis and the locking member axis are parallel.
